(19) United States
(12) Patent Application Publication
(10) Pub. No.: US 2026/0003318 A1
(43) Pub. Date: Jan. 1, 2026

(54) IMAGE FORMING APPARATUS

(71) Applicant: CANON KABUSHIKI KAISHA, Tokyo (JP)

(72) Inventors: Masaki Iwase, Shizuoka (JP); Akinori Mitsumata, Tokyo (JP)

(21) Appl. No.: 19/233,144

(22) Filed: Jun. 10, 2025

(30) Foreign Application Priority Data
Jun. 27, 2024 (JP) 2024-104486

(51) Int. Cl. G03G 21/16; G03G 15/08; G03G 21/20

(52) U.S. Cl. CPC G03G 21/1647; G03G 15/0865; G03G 15/0898; G03G 21/206; G03G 2221/163; G03G 2221/1645

(57) ABSTRACT

An image forming apparatus includes an apparatus body including a photosensitive drum, a developing container, and a developing roller, and a toner cartridge including a toner storage chamber provided with a discharge port, a filter, and an air chamber provided with an inlet port. The apparatus body includes a pump, a first connecting portion including a passage through which the air supplied from the pump and sent toward the air chamber passes, and a second connecting portion including a passage through which the toner discharged from the discharge port together with the air and conveyed toward the developing container passes. In a case where the toner cartridge is detached from the apparatus body, connection between the first connecting portion and the inlet port is released such that the inlet port is opened before connection between the second connecting portion and the discharge port is released.

### BACKGROUND

### Field of the Technology

The present disclosure relates to an image forming apparatus that forms an image on a sheet.

### Description of the Related Art

According to Japanese Patent Application Laid-Open No. 2007-249151, an image forming apparatus including a developing portion configured to develop a photosensitive drum, a toner hopper configured to supply toner to the developing portion, and a powder supply apparatus configured to supply the toner to the toner hopper is proposed. The powder supply apparatus includes a powder storage portion configured to store the toner and a pump configured to suck in the toner stored in the powder storage portion and eject the toner toward the toner hopper. The powder storage portion and the pump are interconnected by a suction tube, and the pump and the toner hopper are interconnected by an ejection tube. The powder storage portion is configured to be replaceable.

However, the powder supply apparatus described in Japanese Patent Application Laid-Open No. 2007-249151 has a risk that in the case where the replacement of the powder storage portion is performed in a state in which the internal pressure of the powder storage portion is higher than the atmospheric pressure, the toner jets out from a connecting port of the powder storage portion connected to the suction tube and leaks to the inside of the apparatus.

### SUMMARY

According to a first aspect of the present disclosure, an image forming apparatus includes an apparatus body including a photosensitive drum configured to bear an electrostatic latent image, a developing container configured to store toner, and a developing roller configured to develop the electrostatic latent image into a toner image by using the toner in the developing container, and a toner cartridge configured to be attachable to and detachable from the apparatus body, the toner cartridge including a toner storage chamber configured to store the toner and provided with a discharge port through which the toner is discharged to an outside of the toner cartridge, a filter configured to suppress passage of the toner and allow passage of air, and an air chamber partitioned from the toner storage chamber by the filter and provided with an inlet port communicating with the air chamber. The apparatus body includes a pump configured to supply the air to the air chamber of the toner cartridge, a first connecting portion configured to be connected to the inlet port of the toner cartridge and including a passage through which the air supplied from the pump and sent toward the air chamber passes, and a second connecting portion configured to be connected to the discharge port of the toner cartridge and including a passage through which the toner discharged from the discharge port together with the air and conveyed toward the developing container passes. In a case where the toner cartridge is detached from the apparatus body, connection between the first connecting portion and the inlet port is released such that the inlet port is opened before connection between the second connecting portion and the discharge port is released.

According to a second aspect of the present disclosure, an image forming apparatus includes an apparatus body including a photosensitive drum configured to bear an electrostatic latent image, a developing container configured to store toner, and a developing roller configured to develop the electrostatic latent image into a toner image by using the toner in the developing container, a toner cartridge configured to be attachable to and detachable from the apparatus body, the toner cartridge including a toner storage chamber configured to store the toner and provided with a discharge port through which the toner is discharged to an outside of the toner cartridge, a filter configured to suppress passage of the toner and allow passage of air, and an air chamber partitioned from the toner storage chamber by the filter and provided with an inlet port communicating with the air chamber, and a valve member. The apparatus body includes a pump configured to supply the air to the air chamber of the toner cartridge, and a supply pipe including a passage through which the air supplied from the pump and sent to the air chamber passes. The valve member is configured to be transitioned to a closed state in which the air chamber does not communicate with the outside of the toner cartridge and an open state in which the air chamber communicates with the outside of the toner cartridge.

According to a third aspect of the present disclosure, an image forming apparatus includes an apparatus body including a photosensitive drum configured to bear an electrostatic latent image, a developing container configured to store toner, and a developing roller configured to develop the electrostatic latent image into a toner image by using the toner in the developing container, and a toner cartridge configured to be attachable to and detachable from the apparatus body, the toner cartridge including a toner storage chamber configured to store the toner and provided with a discharge port through which the toner is discharged to an outside of the toner cartridge, a filter configured to suppress passage of the toner and allow passage of air, and an air chamber partitioned from the toner storage chamber by the filter and provided with an inlet port communicating with the air chamber. The apparatus body includes a pump configured to be transitioned to a supply state in which the pump supplies the air to the air chamber and a suction state in which the pump sucks the air from the air chamber, and a controller configured to cause the pump to be transitioned to the supply state or the suction state.

Features of the present disclosure will become apparent from the following description of embodiments with reference to the attached drawings. The following description of embodiments is described by way of example.

### BRIEF DESCRIPTION OF THE DRAWINGS

FIG. 1 is an overall schematic view of an image forming apparatus according to a first embodiment.

FIG. 2 is a perspective view of the image forming apparatus.

FIG. 3A is a section view taken along a line 3A-3A of FIG. 1.

FIG. 3B is a section view illustrating a state in which a door is open.

FIG. 3C is a section view illustrating how a toner cartridge moves in a detachment direction.

FIG. 4A is an enlarged view of a portion of FIG. 3A indicated by a broken line.

FIG. 4B is an enlarged view of a portion of FIG. 3B indicated by a broken line.

FIG. 5 is a side view of the toner cartridge as viewed from the upstream side in the detachment direction.

FIG. 6A is a section view illustrating a configuration around a toner cartridge according to a second embodiment.

FIG. 6B is a section view illustrating a state in which a door is open.

FIG. 6C is a section view illustrating how a toner cartridge moves in a detachment direction.

FIG. 7 is a section view illustrating a configuration around a toner cartridge according to a third embodiment.

FIG. 8A is an enlarged view for describing an operation of an air releasing valve.

FIG. 8B is an enlarged view for describing the operation of the air releasing valve.

FIG. 9 is a block diagram illustrating a configuration of a control system according to a fourth embodiment.

FIG. 10 is a flowchart illustrating an example of switching of an air conveyance direction of a pump.

FIG. 11 is a flowchart illustrating another example of switching of the air conveyance direction of the pump.

### DESCRIPTION OF THE EMBODIMENTS

### First Embodiment

### Overall Configuration

First, a first embodiment of the present disclosure will be described. The image forming apparatus 100 according to the first embodiment is a full-color laser beam printer of an electrophotographic system. To be noted, examples of the image forming apparatus include printers, copiers, facsimile machines, and multifunctional apparatuses, and the image forming apparatus refers to an apparatus that forms an image on a sheet used as a recording medium on the basis of image information input from an external personal computer (PC) or image information read from a document. In addition, in some cases, the image forming apparatus includes an additional device such as an optional feeder, an image reading apparatus, or a sheet processing apparatus coupled thereto in addition to a body having an image forming function, and the entire system including the additional device coupled thereto also serves as a kind of an image forming apparatus.

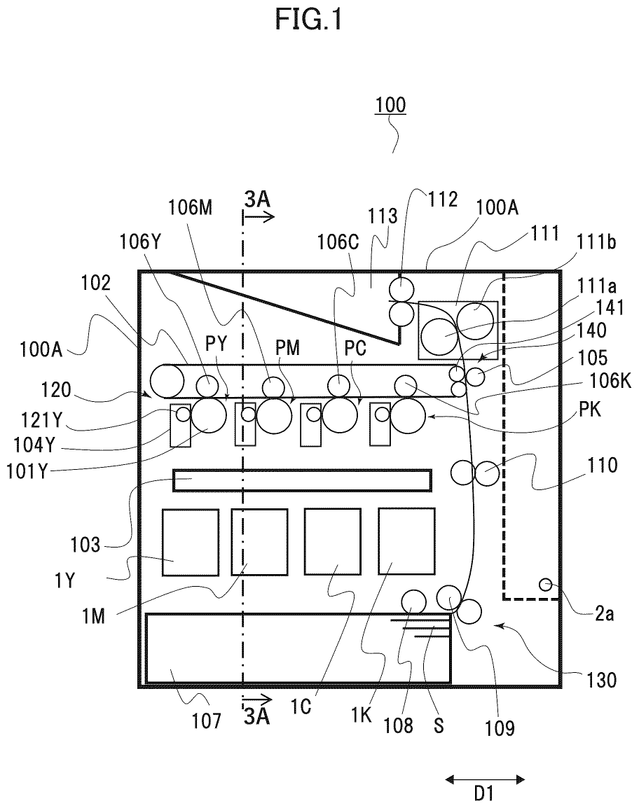

As illustrated in FIG. 1, the image forming apparatus 100 includes an image forming portion 120 that forms an image on a sheet S, a feeding unit 130, a fixing unit 111, and a discharge roller pair 112. The image forming portion 120 includes four process cartridges PY, PM, PC, and PK that respectively form toner images of four colors of yellow (Y), magenta (M), cyan (C), and black (K), and a laser scanner 103. The laser scanner 103 is disposed below the process cartridges PY, PM, PC, and PK. To be noted, a light emitting diode (LED) exposing unit may be used instead of the laser scanner 103.

To be noted, part of the image forming apparatus 100 excluding toner cartridges 1Y, 1M, 1C, and 1K may be referred to as a body of the image forming apparatus 100 or an apparatus body 100A. The process cartridges PY, PM, PC, and PK may be detachably supported with respect to the casing of the apparatus body 100A, and may be fixed to the casing of the apparatus body 100A so as not to be detachable.

In the present embodiment, suffices Y, M, C, and K are attached to reference signs of parts respectively corresponding to yellow, magenta, cyan, and black toners. The configurations and operations of the parts denoted with these suffices are substantially the same except that the color of the toner is different. Therefore, the description below may be given in a generalized manner by omitting the suffices Y to K in the case where no distinction is particularly required.

The process cartridge PY includes a photosensitive drum 101Y, an unillustrated charging roller, a developing container 104Y storing toner, and a developing roller 121Y. The photosensitive drum 101Y includes an aluminum cylinder and an organic photoconductor layer applied on the outer peripheral surface of the aluminum cylinder, and is rotated by an unillustrated driving motor. To be noted, a photosensitive belt may be used instead of the photosensitive drum 101Y. The developing container 104Y stores yellow toner, and the developing roller 121Y develops an electrostatic latent image on the photosensitive drum 101Y by using the toner in the developing container 104Y. The process cartridges PM, PC and PK each have substantially the same configuration as the process cartridge PY.

In addition, the image forming portion 120 is provided with an intermediate transfer belt unit 140 disposed above the process cartridges PY, PM, PC, and PK. The intermediate transfer belt unit 140 includes an intermediate transfer belt 102, primary transfer rollers 106Y, 106M, 106C, and 106K disposed on the inner peripheral side of the intermediate transfer belt 102, a secondary transfer inner roller 141, and a secondary transfer roller 105.

The primary transfer rollers 106Y, 106M, 106C, and 106K are in contact with the respective photosensitive drums of the process cartridges PY, PM, PC, and PK to form primary transfer portions. The secondary transfer roller 105 is disposed to oppose the secondary transfer inner roller 141 with the intermediate transfer belt 102 therebetween. The secondary transfer roller 105 and the intermediate transfer belt 102 are in contact with each other to form a secondary transfer portion.

The fixing unit 111 includes a fixing film 111a heated by a heater, and a pressurizing roller 111b that is in pressure contact with the fixing film 111a. The feeding unit 130 is provided in a lower portion of the image forming apparatus 100. The feeding unit 130 includes a feeding cassette 107 that can be drawn out from and attached to the apparatus body 100A, a pickup roller 108 that feeds the sheet S stored in the feeding cassette 107, and a conveyance roller pair 109. To be noted, examples of the sheet include paper such as paper sheets and envelopes, plastic films such as sheets for overhead projectors (OHP), and cloths.

### Image Forming Operation

Next, the image forming operation of the image forming apparatus 100 configured in this manner will be described. When an image signal is input to the laser scanner 103 from an unillustrated PC or the like, laser light corresponding to the image signal is radiated onto the surface of the photosensitive drum 101Y from the laser scanner 103.

At this time, the surface of the photosensitive drum 101Y is uniformly charged to a predetermined polarity and potential in advance by a charging roller, and an electrostatic latent image is formed on the surface as a result of the surface being irradiated with the laser light from the laser scanner 103. The electrostatic latent image borne on the photosensitive drum 101Y is developed by the developing roller 121Y, and thus a yellow (Y) toner image is formed on the photosensitive drum 101Y.

Similarly, magenta (M), cyan (C), and black (K) toner images are also formed on the respective photosensitive drums of the process cartridges PM, PC, and PK. The toner images of respective colors formed on the respective photosensitive drums are transferred onto the intermediate transfer belt 102 by the primary transfer rollers 106Y, 106M, 106C, and 106K, and are conveyed to the secondary transfer roller 105 by the intermediate transfer belt 102.

To be noted, the image forming process of each color is performed at a timing such that the toner image thereof is superimposed on an upstream toner image that has been already transferred onto the intermediate transfer belt 102 through primary transfer. In addition, after the toner images of the respective colors are transferred onto the intermediate transfer belt 102, toner remaining on the surface of each photosensitive drum is removed by an unillustrated cleaning apparatus.

In parallel with this image forming process, sheets S stored in the feeding cassette 107 of the feeding unit 130 are fed one by one by the pickup roller 108. Then, the sheet S is conveyed toward the secondary transfer portion by the conveyance roller pair 109 and a registration roller pair 110. The registration roller pair 110 may perform skew correction of the sheet S. For example, the skew of the sheet S is corrected by causing the sheet S to abut the nip of the registration roller pair 110 that is not operating. In addition, the conveyance roller pair 109 and the registration roller pair 110 control the conveyance speed of the sheet S, and thus the sheet S is conveyed at a timing matching the image conveyed by the intermediate transfer belt 102.

In the secondary transfer portion, the full-color toner image on the intermediate transfer belt 102 is transferred onto the sheet S by a secondary transfer bias applied to the secondary transfer roller 105. The sheet S onto which the toner image has been transferred is subjected to a predetermined heat and pressure from a fixing film 111a and a pressurizing roller 111b of a fixing unit 111, and thus the toner melts and adheres (is fixed). The sheet S having passed through the fixing unit 111 is discharged by the discharge roller pair 112, and is supported on a discharge tray 113 provided in an upper portion of the apparatus body 100A.

### Schematic Configuration of Toner Cartridge

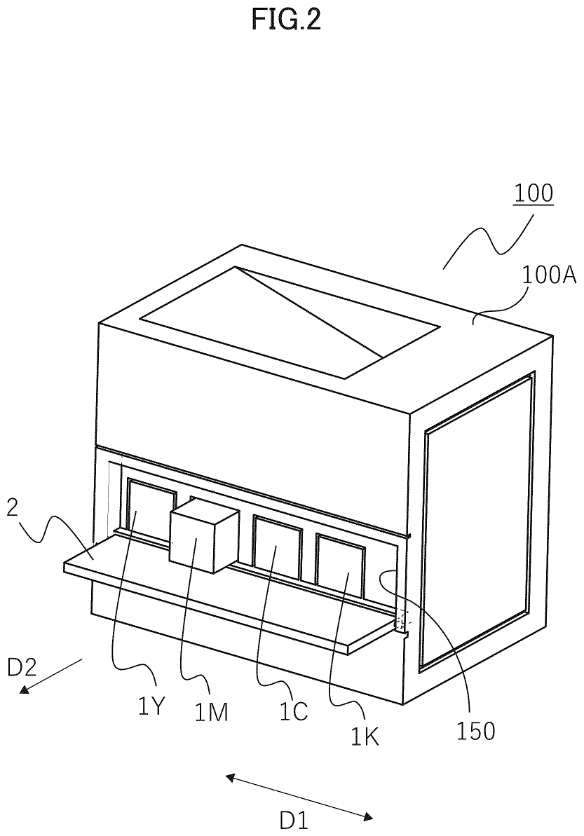

Next, a schematic configuration of the toner cartridges 1Y, 1M, 1C, and 1K will be described with reference to FIG. 2. FIG. 2 is a perspective view of the image forming apparatus 100. As illustrated in FIG. 2, the apparatus body 100A has an opening portion 150 provided in a casing of the apparatus body 100A and includes a door 2 capable of opening and closing the opening portion 150. The door 2 is configured to be movable (pivotable) about a pivot shaft 2a (see FIG. 1) to an open position where the door 2 opens the opening portion 150 and a closed position where the door 2 closes the opening portion 150, and is disposed on the front side of the image forming apparatus 100. In addition, the posture of the door 2 can be maintained at the closed position or the open position.

When the door 2 is opened from the closed position to the open position, the toner cartridges 1Y, 1M, 1C, and 1K are exposed to the outside of the image forming apparatus 100 through the opening portion 150. Therefore, the user can access the toner cartridges 1Y, 1M, 1C, and 1K. The toner cartridges 1Y, 1M, 1C, and 1K can replenish the developing containers 104 of the process cartridges PY, PM, PC, and PK with toner.

The toner cartridges 1Y, 1M, 1C, and 1K are arranged (aligned) in an arrangement direction D1. In addition, the process cartridges PY, PM, PC, and PK are also arranged in the arrangement direction D1 similarly to the toner cartridges 1Y, 1M, 1C, and 1K. The toner cartridges 1Y, 1M, 1C, and 1K are configured to be attachable to and detachable from the apparatus body 100A. That is, the toner cartridges 1Y, 1M, 1C, and 1K are moved in the attachment direction, and thus each reach an attached position where the toner cartridge is attached to the apparatus body 100A. In addition, the toner cartridges 1Y, 1M, 1C, and 1K are configured to be separated from the attached position by being moved in a detachment direction d2 that is a direction opposite to the attachment direction. The attachment direction and the detachment direction D2 each intersect with the arrangement direction D1. FIG. 2 illustrates how the toner cartridge 1M is detached from the apparatus body 100A in the detachment direction D2.

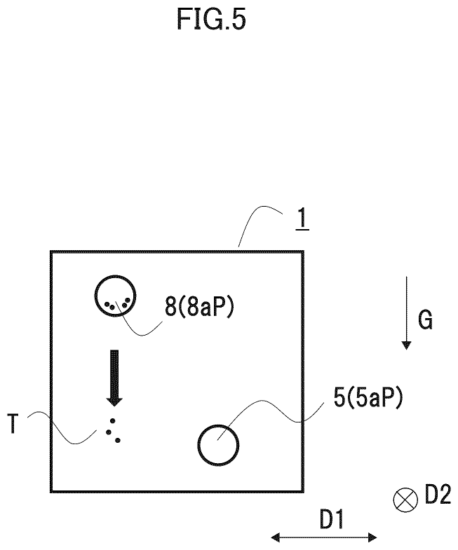

To be noted, the detachment direction D2 of the present embodiment is a direction along the horizontal direction. The arrangement direction D1 and the detachment direction D2 are both orthogonal to the gravity direction G (see FIG. 5). To be noted, the gravity direction G is a direction orthogonal to the horizontal direction, and can be also referred to as a vertical direction.

To be noted, the toner cartridges 1Y, 1M, 1C, and 1K may be configured to be detachable from the apparatus body 100A in the case where the toner remainder amount therein is equal to or less than a predetermined amount. In addition, a cartridge tray serving as a support member that is supported to be movable in the detachment direction D2 and the attachment direction with respect to the apparatus body 100A and that supports the toner cartridges 1Y, 1M, 1C, and 1K. That is, the toner cartridges 1Y, 1M, 1C, and 1K may be configured to be simultaneously detached from the apparatus body 100A when the cartridge tray is drawn out in the detachment direction D2 from the apparatus body 100A.

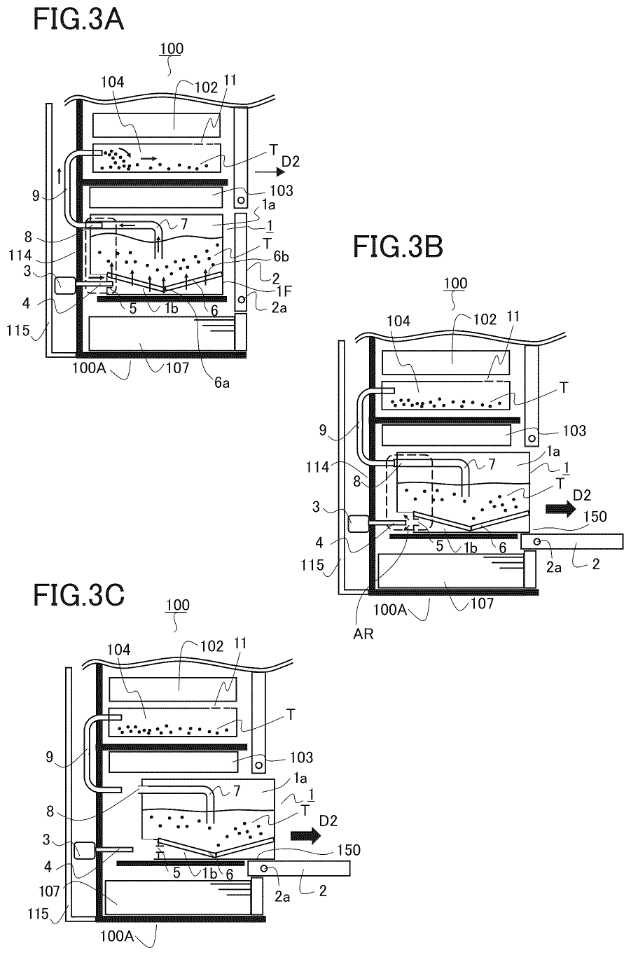

FIG. 3A is a section view illustrating a section 3A-3A of FIG. 1, FIG. 3B is a section view illustrating a state in which the door 2 is open, and FIG. 3C is a section view illustrating how the toner cartridge 1 moves in the detachment direction D2. To be noted, FIGS. 3B and 3C also illustrate the section 3A-3A of FIG. 1.

The toner cartridges 1Y, 1M, 1C, and 1K each have substantially the same configuration, and therefore these will be described as toner cartridges 1 without particular distinction in the description below. In addition, the pump 3, the first pipe 4, and the second pipe 9 are provided in the same number as the toner cartridges in the apparatus body 100A, and these will be also described without particular distinction.

As illustrated in FIG. 3A, the toner cartridge 1 includes a frame body 1F and a filter 6 fixed to the frame body 1F. The filter 6 partitions the inner space of the frame body 1F into a toner storage chamber 1a storing toner T and an air chamber 1b. That is, it can be said that the toner cartridge 1 includes the toner storage chamber 1a and the air chamber 1b. The air chamber 1b is disposed below the filter 6, and the toner storage chamber 1a is disposed above the filter 6.

The frame body 1F is formed from a resin material in the present embodiment, but may be formed from paper, rubber, or the like. In addition, the frame body 1F may be constituted by a plurality of members instead of a single member. For example, the frame body 1F may be constituted by two frame members sandwiching the filter 6. The filter 6 is constituted by, for example, a porous member formed from resin fiber. The pores of the filter 6 have such sizes and density as to allow passage of air but restrict passage of the toner T. That is, the filter 6 is configured to allow passage of air but suppress passage of the toner T. In addition, the filter 6 has a shape inclined toward a lowermost portion 6a that is positioned below an outer edge portion. That is, the filter 6 includes an inclined portion 6b that is inclined such that a portion thereof closer to the lowermost portion 6a in the horizontal direction is lower.

The apparatus body 100A includes a pump 3 for conveying air to the air chamber 1b of the toner cartridge 1, a first pipe 4, and a second pipe 9. The pump 3 is disposed outside a frame body 114 of the apparatus body 100A defining a space for accommodating the toner cartridge 1, and is disposed between the frame body 114 and an exterior cover 115. Therefore, even in the case where the pump 3 needs to be replaced, the pump 3 can be accessed from the rear side of the image forming apparatus 100 by detaching the exterior cover 115 from the frame body 114.

The first pipe 4 interconnects the pump 3 and the air chamber 1b, and conveys air from the pump 3 to the air chamber 1b. The second pipe 9 interconnects the toner storage chamber 1a and the developing container 104, and conveys air from the toner storage chamber 1a to the developing container 104 together with toner. More specifically, the toner cartridge 1 is provided with a first connected portion 5 and a second connected portion 8, and the first pipe 4 and the second pipe 9 are respectively connected to the first connected portion 5 and the second connected portion 8. In addition, the first pipe 4 is connected to the first connected portion 5 from the upstream side in the detachment direction D2 of the toner cartridge 1, and the second pipe 9 is connected to the second connected portion 8 from the upstream side in the detachment direction D2 of the toner cartridge 1. In addition, the second pipe 9 is connected to the developing container 104 from the upstream side in the detachment direction D2.

In addition, the toner storage chamber 1a is provided with a toner discharge pipe 7, and the toner T stored in the toner storage chamber 1a is conveyed to the developing container 104 in the apparatus body 100A through the toner discharge pipe 7, the second connected portion 8, and the second pipe 9. One end of the toner discharge pipe 7 opposes the lowermost portion 6a of the filter 6, and the other end thereof is connected to the second connected portion 8. To be noted, although the second connected portion 8 is integrally provided with the frame body 1F of the toner cartridge 1 and includes a pipe portion 8a interconnecting the toner discharge pipe 7 and the second pipe 9 in the present embodiment, the configuration is not limited to this. For example, the pipe portion 8a may be provided integrally with the toner discharge pipe 7 and engaged with the second pipe 9. In addition, the pipe portion 8a may be provided separately from the frame body 1F and the toner discharge pipe 7.

Next, a mechanism in which the toner Tis conveyed to the developing container 104 will be described. When the pump 3 operates, air is sent to the air chamber 1b through the first pipe 4. Then, this air fills the air chamber 1b, and flows into the toner storage chamber 1a through the filter 6.

The air having flowed into the toner storage chamber 1a goes between particles of the toner T to fluidize the toner T. The pressure in the toner cartridge 1 becomes a positive pressure as a result of the flow-in of the air from the pump 3, and the air tries to get out of the toner cartridge 1 from the second connected portion 8 through the toner discharge pipe 7.

At this time, the toner T in the toner storage chamber 1a is moved through the toner discharge pipe 7 together with the air, and is discharged to the outside of the toner cartridge 1 from the second connected portion 8. That is, the toner discharge pipe 7 guides the toner T in the toner storage chamber 1a to the second connected portion 8 together with the air. The toner T discharged from the second connected portion 8 enters the developing container 104 through the second pipe 9. As a result of this, the developing container 104 is replenished with the toner T.

Since not only the toner T but also the air flows into the developing container 104, the inner pressure of the developing container 104 increases. Therefore, in the present embodiment, an exhaustion portion 11 is provided in the upper surface of the developing container 104. The exhaustion portion 11 is constituted by a through hole provided in the developing container 104 and an unillustrated exhaustion filter covering the through hole. The exhaustion filter is constituted by an unwoven fabric or the like, and is configured to allow passage of air and restrict passage of toner. As a result of this, discharge of the toner having flowed into the developing container 104 to the outside is restricted by the exhaustion filter, and the toner remains in the developing container 104. In contrast, at least part of the air having flowed into the developing container 104 is discharged to the outside of the developing container 104 through the exhaustion filter. As a result of this, the increase in the inner pressure of the developing container 104 is suppressed, and replenishment of the developing container 104 with toner can be performed smoothly.

### Detachment of Toner Cartridge

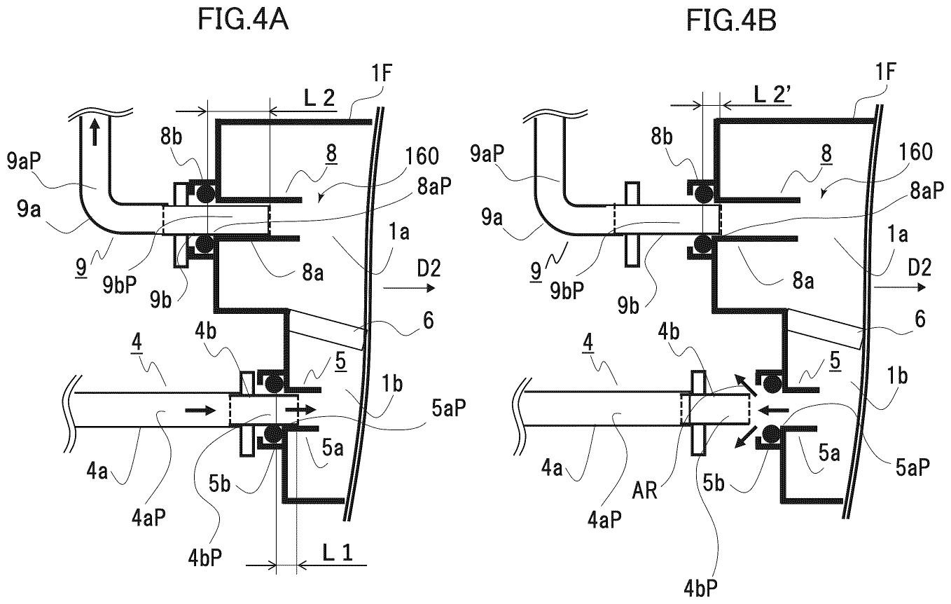

Next, elements for detaching the toner cartridge 1 from the apparatus body 100A and the detachment operation will be described with reference to FIGS. 3A to 5. FIG. 4A is an enlarged view of a portion of FIG. 3A indicated by a broken line, and FIG. 4B is an enlarged view of a portion of FIG. 3B indicated by a broken line. FIG. 5 is a side view of the toner cartridge 1 as viewed from the upstream side in the detachment direction D2.

As illustrated in FIG. 4A, the first pipe 4 includes an air conveyance tube 4a, and a first connecting portion 4b that communicates with the air conveyance tube 4a and that is inserted in the first connected portion 5. The air conveyance tube 4a serving as a supply pipe has a passage 4aP that the air supplied from the pump 3 passes through to be sent to the air chamber 1b. In addition, the first connecting portion 4b is formed in a tubular shape and includes a passage 4bP that the air supplied from the pump 3 passes through to be sent to the air chamber 1b. That is, the air supplied from the pump 3 is sent from an inlet port 5aP′ to the air chamber 1b through the passages 4aP and 4bP.

The first connected portion 5 is formed integrally with the frame body 1F, and includes a pipe portion 5a defining the inlet port 5aP communicating with the air chamber 1b, and an O ring 5b that is in firm contact with the outer peripheral surface of the first connecting portion 4b. To be noted, it can be also said that the air chamber 1b is provided with the inlet port 5aP. The first connecting portion 4b of the first pipe 4 is inserted in the pipe portion 5a of the first connected portion 5. That is, the first connecting portion 4b is connected to the inlet port 5aP of the pipe portion 5a. At this time, the O ring 5b serving as a first sealing member seals a gap between the first connecting portion 4b and the pipe portion 5a that is a part defining the inlet port 5aP.

The second pipe 9 includes a toner conveyance tube 9a and a second connecting portion 9b that communicates with the toner conveyance tube 9a and that is inserted in the second connected portion 8. The toner conveyance tube 9a serving as a pipe has a passage 9aP that the toner T discharged from the toner cartridge 1 through the second connecting portion 9b together with air passes through. In addition, the second connecting portion 9b is formed in a tubular shape, and includes a passage 9bP that the toner T discharged from the toner cartridge 1 together with air passes through. That is, the toner T discharged from the discharge port 8aP of the toner storage chamber 1a is sent to the developing container 104 through the passages 9bP and 9aP.

In addition, the second pipe 9 is disposed so as not to interfere with the laser optical path, other units of the image forming apparatus 100 such as the laser scanner 103 positioned between the toner cartridge 1 and the developing container 104, and the like. The second connected portion 8 is formed integrally with the frame body 1F, and includes a pipe portion 8a provided with a discharge port 8aP through which the toner T in the toner storage chamber 1a is discharged to the outside of the toner cartridge 1, and an O ring 8b that is in firm contact with the outer peripheral surface of the second connecting portion 9b. To be noted, it can be also said that the toner storage chamber 1a is provided with the discharge port 8aP. The second connecting portion 9b of the second pipe 9 is inserted in the pipe portion 8a of the second connected portion 8. That is, the second connecting portion 9b is connected to the discharge port 8aP of the pipe portion 8a. At this time, the O ring 8b serving as a second sealing member seals a gap between the second connecting portion 9b and the pipe portion 8a that is a part defining the discharge port 8aP.

To be noted, although the first connecting portion 4b is provided integrally with the air conveyance tube 4a in the present embodiment, the configuration is not limited to this. For example, the first connecting portion 4b may be constituted by a member different from the air conveyance tube 4a. In addition, the first connecting portion 4b may be directly connected to the pump 3 and the inlet port 5aP of the air chamber 1b. Similarly, although the second connecting portion 9b is provided integrally with the toner conveyance tube 9a in the present embodiment, the configuration is not limited to this. For example, the second connecting portion 9b may be constituted by a member different from the toner conveyance tube 9a. In addition, the second connecting portion 9b may be directly connected to the developing container 104 and the discharge port 8aP of the toner storage chamber 1a.

The first connected portion 5 is configured such that the first connecting portion 4b of the first pipe 4 is inserted in the air chamber 1b by just a first distance L1 from the O ring 5b in the detachment direction D2 in the case where the toner cartridge 1 is at the attached position. In addition, the second connected portion 8 is configured such that the second connecting portion 9b of the second pipe 9 is inserted in the toner storage chamber 1a by just a second distance L2 from the O ring 8b in the detachment direction D2 in the case where the toner cartridge 1 is at the attached position. The second distance L2 is set to be longer than the first distance L1. At the attached position, the toner cartridge 1 is attached to the apparatus body 100A, and can convey the toner T toward the developing container 104.

As described above, in the present embodiment, the first pipe 4 and the second pipe 9 are respectively loosely inserted in the first connected portion 5 and the second connected portion 8, and the O rings 5b and 8b are respectively in firm contact with the outer peripheral surfaces of the first connecting portion 4b and the second connecting portion 9b. As a result of this, the acceptable range of the attached position of the toner cartridge 1 can have a certain margin, and leakage of the air from the first connected portion 5 and the second connected portion 8 can be suppressed by the O rings 5b and 8b.

As illustrated in FIG. 3B, when detaching the toner cartridge 1 from the apparatus body 100A, the user first moves the door 2 from the closed position to the open position. Then, the user draws out the toner cartridge 1 from the apparatus body 100A in the detachment direction D2. At this time, the toner cartridge 1 is drawn out while being supported by the upper surface of the door 2.

Then, as illustrated in FIG. 4B, the first connecting portion 4b of the first pipe 4 is detached from the first connected portion 5 in a state in which the second pipe 9 is connected to the toner storage chamber 1a of the toner cartridge 1. When the toner cartridge 1 moves in the detachment direction D2 from the attached position, the first connected portion 5 is detached from the first pipe 4 before the second connected portion 8 is detached from the second pipe 9. In other words, when the toner cartridge 1 is detached from the apparatus body 100A, the connection between the first connecting portion 4b and the inlet port 5aP is released before the connection between the second connecting portion 9b and the discharge port 8aP is released. As a result of this, the inlet port 5aP is opened. This is because the second distance L2 is longer than the first distance L1. That is, when the toner cartridge 1 moves in the detachment direction D2 by just the first distance L1 from the attached position, the second connected portion 8 is detached from the first connecting portion 4b. Further, in the case where the movement distance in the detachment direction D2 from the attached position of the toner cartridge 1 is equal to or longer than the first distance L1 and shorter than the second distance L2, the connected state between the second connected portion 8 and the second connecting portion 9b is maintained. For example, in FIG. 4B, the second connecting portion 9b is still inserted in the second connected portion 8 by just a distance L2′.

As a result of the detachment of the first connected portion 5 from the first connecting portion 4b, the first connected portion 5 communicates with the outside of the toner cartridge 1, and the inner pressure of the toner cartridge 1 becomes approximately equal to the atmospheric pressure. For example, when clogging occurs at somewhere in the toner conveyance path from the toner cartridge 1 to the developing container 104, the inner pressure of the toner cartridge 1 can be higher than the atmospheric pressure. Further, in the case where the first connected portion 5 is detached from the first pipe 4 in the state in which the inner pressure of the toner cartridge 1 is higher than the atmospheric pressure, air AR is discharged to the outside of the toner cartridge 1 from the first connected portion 5 until the inner pressure of the toner cartridge 1 becomes approximately equal to the atmospheric pressure. The first connected portion 5 and the second connected portion 8 constitute a decompression mechanism 160 that reduces the inner pressure of the toner cartridge 1 in a state in which the toner storage chamber 1a and the second pipe 9 are connected.

As illustrated in FIG. 3C, when the toner cartridge 1 is further moved in the detachment direction D2, the second connecting portion 9b is detached from the second connected portion 8, and thus the first connecting portion 4b and the second connecting portion 9b are both detached from the toner cartridge 1. This is because the movement distance in the detachment direction D2 from the attached position of the toner cartridge 1 is equal to or longer than the second distance L2. At this time, the inner pressure of the toner cartridge 1 is approximately equal to the atmospheric pressure, and therefore the toner T in the toner storage chamber 1a does not jet out from the second connected portion 8 even if the second pipe 9 is detached from the second connected portion 8. Therefore, toner leakage in the case of replacing the toner cartridge 1 can be suppressed.

To be noted, there are various methods to detach the toner cartridge 1 from the apparatus body 100A, and the detachment method is not limited. For example, the toner cartridge 1 may be detached from the apparatus body 100A by a user pulling an unillustrated grip portion of the toner cartridge 1. In addition, a configuration in which the apparatus body 100A is provided with a push-out mechanism that pushes out the toner cartridge 1 to the outside of the apparatus body 100A and the toner cartridge 1 is moved in the detachment direction D2 by the push-out mechanism when the door 2 moves from the closed position to the open position may be employed. That is, a configuration in which the toner cartridge 1 moves in the detachment direction D2 from the attached position in conjunction with the movement of the door 2 from the closed position to the open position may be employed. For the push-out mechanism, for example, an urging force of a spring can be used, or an actuator such as a solenoid can be used.

As illustrated in FIG. 5, the second connected portion 8 is disposed above the first connected portion 5, and is disposed at a different position from the first connected portion 5 in the arrangement direction D1 that is a direction orthogonal to both the detachment direction D2 and the gravity direction G. That is, the discharge port 8aP is disposed above the inlet port 5aP, and is disposed at a different position from the inlet port 5aP in the arrangement direction D1 that is a direction orthogonal to both the detachment direction D2 and the gravity direction G. As described above, since the inlet port 5aP is not disposed right under the discharge port 8aP, attachment of the toner T to the inlet port 5aP can be suppressed even in the case where the toner T attached to a portion near the discharge port 8aP drops when detaching the toner cartridge 1 from the apparatus body 100A. As a result of this, attachment of the toner T between the first connected portion 5 and the first pipe 4, particularly near the O ring 5b can be suppressed, and thus deterioration of the airtightness between the first pipe 4 and the first connected portion 5 can be suppressed. In addition, a situation in which the toner T enters the air chamber 1b from the first connected portion 5 and the filter 6 is clogged to lower the toner discharge performance can be suppressed.

Further, the first connected portion 5 and the second connected portion 8 are disposed within a projection area of the toner cartridge 1 as viewed in the detachment direction D2. As a result of this, the toner cartridge 1 can be miniaturized in the gravity direction G and the arrangement direction D1.

### Second Embodiment

A second embodiment of the present disclosure will be described next. The second embodiment is configured by providing the toner cartridge 1 with an air releasing valve 12 instead of the decompression mechanism 160 of the first embodiment. Therefore, elements substantially the same as in the first embodiment will be omitted from illustration, or denoted by the same reference signs in the drawings for description.

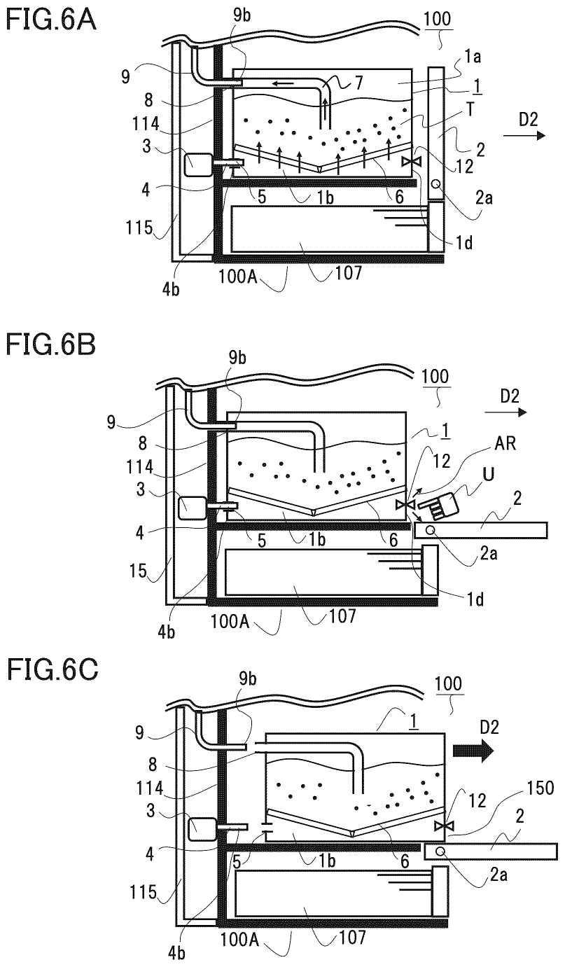

FIG. 6A is a section view illustrating a configuration around the toner cartridge 1 according to the second embodiment. FIG. 6B is a section view illustrating a state in which the door 2 is open, and FIG. 6C is a section view illustrating how the toner cartridge 1 moves in the detachment direction D2. To be noted, FIGS. 6A, 6B, and 6C illustrate the same cross-section as the section 3A-3A of FIG. 1.

As illustrated in FIG. 6A, the toner cartridge 1 according to the second embodiment is provided with the air releasing valve 12. The air releasing valve 12 interconnects the air chamber 1b of the toner cartridge 1 and the outside of the toner cartridge 1. Further, the air releasing valve 12 can transition to a closed state in which the air chamber 1b does not communicate with the outside of the toner cartridge 1 and an open state in which the air chamber 1b communicates with the outside of the toner cartridge 1.

As illustrated in FIG. 6B, when detaching the toner cartridge 1 from the apparatus body 100A, the user first moves the door 2 from the closed position to the open position. The air releasing valve 12 is disposed in a side surface 1d serving as a surface facing in the detachment direction D2 of the toner cartridge 1. In addition, the air releasing valve 12 is disposed to oppose the door 2 positioned at the closed position. In addition, as a result of providing the air releasing valve 12 in this manner, a user U can access the air releasing valve 12 by opening the door 2.

Then, the user U operates the air releasing valve 12 to transition from the closed state to the open state while the toner cartridge 1 is still positioned at the attached position. As a result of this, the inner pressure of the toner cartridge 1 can be reduced in a state in which the second connecting portion 9b is connected to the toner storage chamber 1a of the toner cartridge 1. That is, in the present embodiment, the air releasing valve 12 serves as an example of a valve member that reduces the pressure of the toner cartridge 1. As a result of the air releasing valve 12 taking the open state, the inner pressure of the toner cartridge 1 becomes approximately equal to the atmospheric pressure. For example, in the case where the air releasing valve 12 is switched to the open state in a state in which the inner pressure of the toner cartridge 1 is higher than the atmospheric pressure, the air AR is discharged to the outside of the toner cartridge 1 through the air releasing valve 12 until the inner pressure of the toner cartridge 1 is approximately equal to the atmospheric pressure.

As illustrated in FIG. 6C, when the toner cartridge 1 is moved in the detachment direction D2 from the attached position, the first connecting portion 4b and the second connecting portion 9b are both detached from the toner cartridge 1. Particularly, when the second connecting portion 9b is detached from the second connected portion 8 of the toner cartridge 1, the inner pressure of the toner cartridge 1 is approximately equal to the atmospheric pressure, and therefore the toner T in the toner storage chamber 1a does not jet out from the second connected portion 8. Therefore, toner leakage in the case of replacing the toner cartridge 1 can be suppressed.

To be noted, the air releasing valve 12 may have a function as a gripping portion for gripping the toner cartridge 1. In addition, the air releasing valve 12 may be configured to transition from the closed state to the open state when the user U pulls the air releasing valve 12 in the detachment direction D2 while gripping the air releasing valve 12.

In addition, although the air releasing valve 12 is disposed in the side surface 1d of the toner cartridge 1 in the present embodiment, the configuration is not limited to this. For example, the first pipe 4 may be provided to extend in such a shape that the first pipe 4 can be accessed when the door 2 is opened, and the air releasing valve 12 may be disposed at a position in the first pipe 4 that the user can access. Also in this case, the air in the air chamber 1b of the toner cartridge 1 is released from the air releasing valve 12 through the first pipe 4 when the air releasing valve 12 transitions to the open state, and thus the inner pressure of the toner cartridge 1 can be reduced to the atmospheric pressure.

### Third Embodiment

A third embodiment of the present disclosure will be described next. The third embodiment is configured by providing the first pipe 4 with an air releasing valve 13 instead of the decompression mechanism 160 of the first embodiment. Therefore, elements substantially the same as in the first embodiment will be omitted from illustration, or denoted by the same reference signs in the drawings for description.

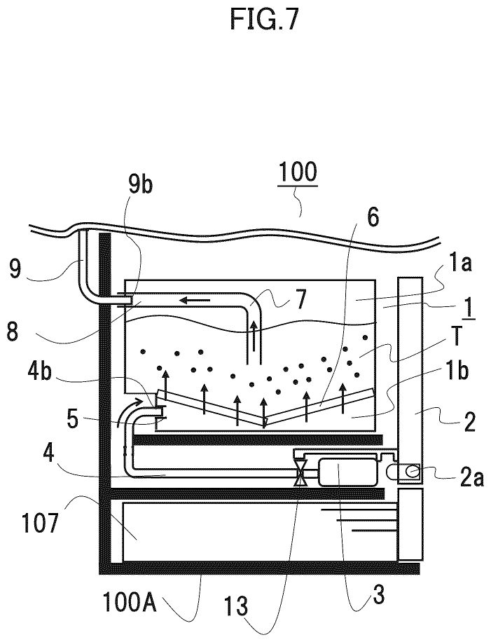

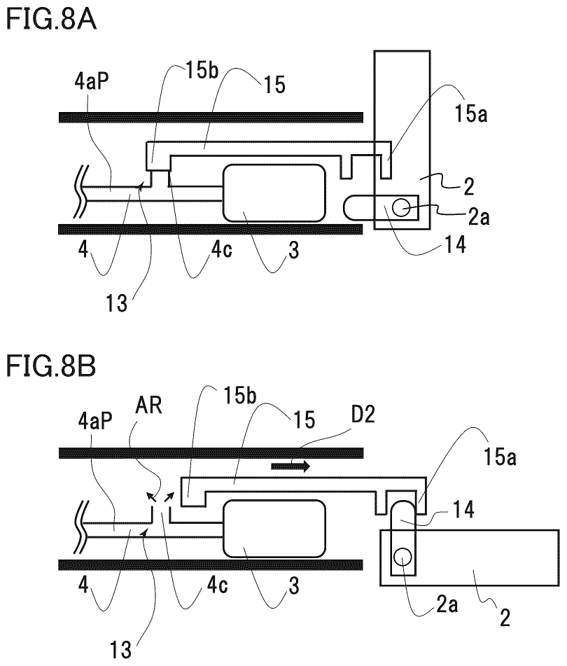

FIG. 7 is a section view illustrating a peripheral configuration of the toner cartridge 1 according to the third embodiment. To be noted, FIG. 7 illustrates the same cross-section as the section 3A-3A of FIG. 1. FIGS. 8A and 8b are each an enlarged view for describing the operation of the air releasing valve 13.

As illustrated in FIG. 7, in the present embodiment, the pump 3 is disposed at a position opposing the door 2 positioned at the closed position, and the first pipe 4 interconnecting the pump 3 and the air chamber 1b of the toner cartridge 1 is provided to extend below the toner cartridge 1. The first pipe 4 is provided with the air releasing valve 13 that will be described later. The air releasing valve 13 interconnects the passage 4aP of the first pipe 4 and the outside of the toner cartridge 1.

As illustrated in FIG. 8A, a link arm 14 is fixed to the door 2, and the link arm 14 pivots about the pivot shaft 2a integrally with the door 2 that pivots about the pivot shaft 2a. A link lever 15 is provided above the pump 3, and the link lever 15 includes an engagement portion 15a capable of engaging with the link arm 14, and a valve sealing portion 15b provided at an end portion on the opposite side to the engagement portion 15a.

The first pipe 4 is provided with an opening portion 4c capable of communicating with the outside of the toner cartridge 1, and the opening portion 4c communicates with the passage 4aP of the first pipe 4 that the air supplied from the pump 3 passes through. In a state in which the door 2 is positioned at the closed position, the opening portion 4c is sealed by the valve sealing portion 15b of the link lever 15. Further, as illustrated in FIG. 8B, when the door 2 moves from the closed position to the open position, the link arm 14 that integrally pivots with the door 2 engages with the engagement portion 15a of the link lever 15, and thus the link lever 15 moves in the detachment direction D2.

By moving the link lever 15 in the detachment direction D2, the valve sealing portion 15b of the link lever 15 is separated from the opening portion 4c, and thus the opening portion 4c is opened. That is, the opening portion 4c of the first pipe 4 and the valve sealing portion 15b of the link lever 15 constitute the air releasing valve 13. The air releasing valve 13 can transition to a closed state in which the passage 4aP of the first pipe 4 does not communicate with the outside of the toner cartridge 1 and an open state in which the passage 4aP of the first pipe 4 communicates with the outside of the toner cartridge 1. In the case where the air releasing valve 13 is in the closed state, the opening portion 4c is closed by the valve sealing portion 15b. In the case where the air releasing valve 13 is in the open state, the opening portion 4c is separated from the valve sealing portion 15b, and the opening portion 4c is open. Further, the air releasing valve 13 transitions from the closed state to the open state in conjunction with the movement of the door 2 from the closed position to the open position.

By configuring the air releasing valve 13 in this manner, the inner pressure of the toner cartridge 1 can be reduced through the opening portion 4c of the first pipe 4 in a state in which the second connecting portion 9b is connected to the toner storage chamber 1a of the toner cartridge 1. That is, in the present embodiment, the air releasing valve 13 serves as an example of a valve member and a pressure reduction mechanism. As a result of the air releasing valve 13 taking the open state, the inner pressure of the toner cartridge 1 becomes approximately equal to the atmospheric pressure. For example, in the case where the air releasing valve 13 is switched to the open state in a state in which the inner pressure of the toner cartridge 1 is higher than the atmospheric pressure, the air AR is discharged to the outside of the toner cartridge 1 through the air releasing valve 13 until the inner pressure of the toner cartridge 1 is approximately equal to the atmospheric pressure.

When the toner cartridge 1 is moved in the detachment direction D2 from the attached position, the first connecting portion 4b and the second connecting portion 9b are both detached from the toner cartridge 1. Particularly, when the second connecting portion 9b is detached from the second connected portion 8 of the toner cartridge 1, the toner T in the toner storage chamber 1a does not jet out from the second connected portion 8 even if the second pipe 9 is detached from the second connected portion 8. Therefore, toner leakage in the case of replacing the toner cartridge 1 can be suppressed. In addition, the air releasing valve 13 transitions from the closed state to the open state in conjunction with the movement of the door 2 from the closed position to the open position, therefore the air releasing valve 13 does not have to be operated after the user opens the door 2, and thus the usability can be improved.

To be noted, in the second embodiment and the third embodiment, the distance L1 that is an insertion distance by which the first connecting portion 4b is inserted into the first connected portion 5 and the distance L2 that is an insertion distance by which the second connecting portion 9b is inserted into the second connected portion 8 are not particularly limited (see FIG. 4A). That is, the distance L1 and the distance 12 are set to be equal, and the first connecting portion 4b and the second connecting portion 9b may be simultaneously detached from the toner cartridge 1 as a result of the toner cartridge 1 moving in the detachment direction D2 from the attached position. In addition, similarly to the first embodiment, the distance L2 may be set to be longer than the distance L1. In addition, the distance L2 may be set to be shorter than the distance L1 such that the second connecting portion 9b is detached from the toner cartridge 1 earlier than the first connecting portion 4b when the toner cartridge 1 is detached from the apparatus body 100A.

In addition, although the link lever 15 is configured to move in the detachment direction D2 in conjunction with the door 2 in the present embodiment, the configuration is not limited to this. For example, the link lever 15 may be configured to move in the gravity direction G or the arrangement direction D1 (see FIG. 2).

In addition, although the air releasing valve 13 is provided in the first pipe 4 in the present embodiment, the configuration is not limited to this. For example, the air releasing valve 13 may be provided in the toner cartridge 1 and transition from the closed state to the open state in conjunction with the movement of the door 2 from the closed position to the open position. That is, the air releasing valve 13 may be configured to be capable of transitioning to a closed state in which the path between the air chamber 1b of the toner cartridge 1 and the outside of the toner cartridge 1 is closed, and an open state in which the air chamber 1b is open to the outside of the toner cartridge 1.

### Fourth Embodiment

Next, a fourth embodiment of the present disclosure will be described. The fourth embodiment has a configuration in which the air conveyance direction of the pump 3 is configured to be switchable instead of using the decompression mechanism 160 of the first embodiment. Therefore, elements substantially the same as in the first embodiment will be omitted from illustration, or denoted by the same reference signs in the drawings for description.

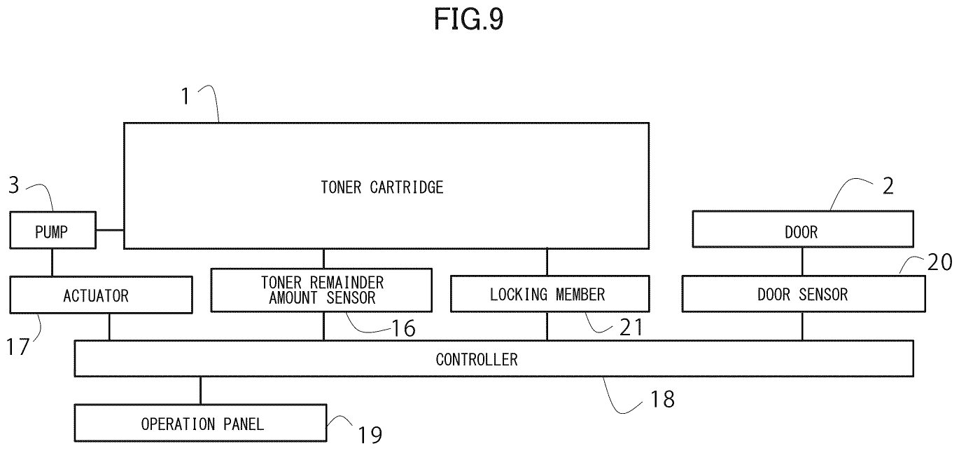

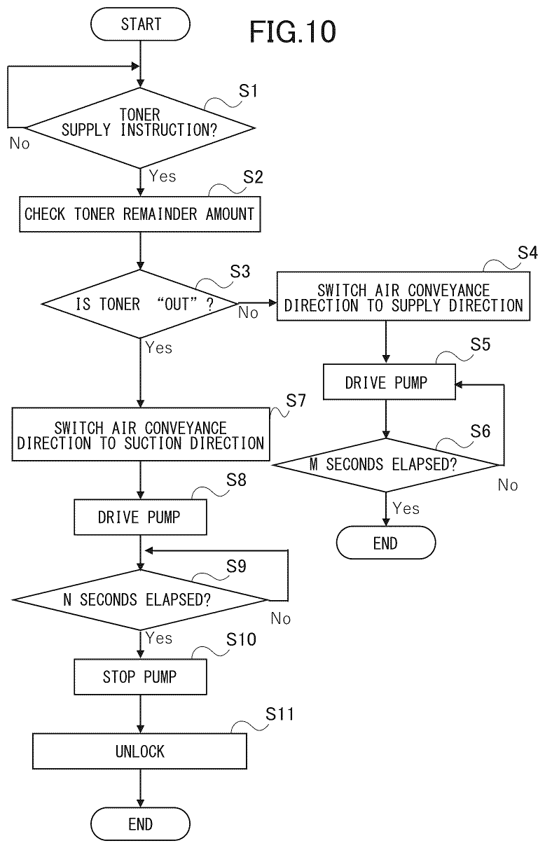

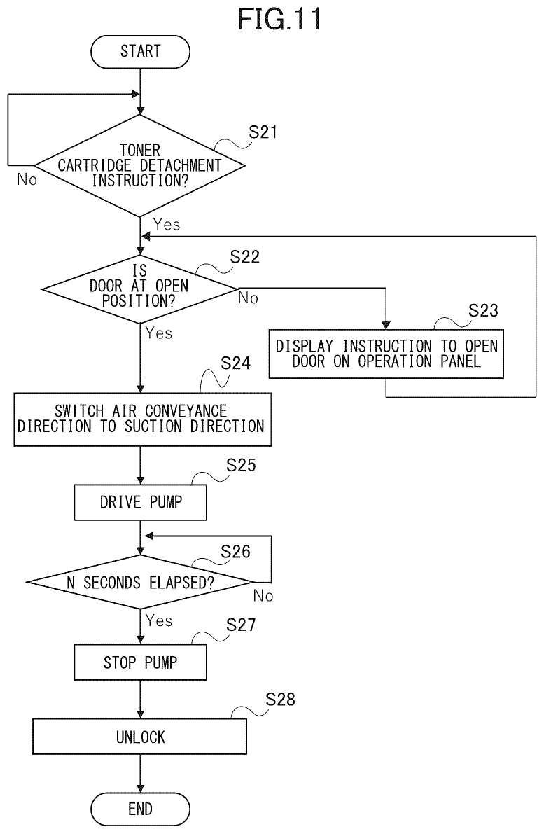

FIG. 9 is a block diagram illustrating a configuration of a control system according to the fourth embodiment. FIG. 10 is a flowchart illustrating an example of switching of the air conveyance direction of the pump 3. FIG. 11 is a flowchart illustrating another example of switching of the air conveyance direction of the pump 3. As illustrated in FIG. 9, the image forming apparatus 100 (see FIG. 1) includes a controller 18, and the controller 18 is connected to a toner remainder amount sensor 16, a locking member 21, a door sensor 20, and an operation panel 19.

The toner remainder amount sensor 16 can detect the remainder amount of the toner T stored in the toner storage chamber 1a of the toner cartridge 1. That is, the toner remainder amount sensor 16 outputs a signal corresponding to the remainder amount of the toner stored in the toner cartridge 1. For example, the toner remainder amount sensor 16 is constituted by an optical sensor including a light emitting portion and a light receiving portion, and an optical path between the light emitting portion and the light receiving portion is set to extend in the toner storage chamber 1a. Further, the toner remainder amount in the toner storage chamber 1a is detected in accordance with, for example, a time in which the optical path is blocked by the toner T.

The locking member 21 is capable of, on the basis of a command from the controller 18, transitioning to a locked state in which the toner cartridge 1 is locked to the apparatus body 100A at the attached position, and an unlocked state in which the detachment of the toner cartridge 1 from the apparatus body 100A is allowed. The door sensor 20 detects the opening/closing state of the door 2. That is, the door sensor 20 outputs a signal that differs between a case where the door 2 is at the closed position and a case where the door 2 is at the open position. An operation panel 19 serving as an operation portion includes, for example, a touch panel, and is capable of outputting various signals to the controller 18 in response to operation by a user.

In addition, the controller 18 can control the actuator 17 and the pump 3, and the actuator 17 can switch the air conveyance direction of the pump 3 by acting on the pump 3. That is, the air conveyance direction of the pump 3 is switched between a supply direction in which the air is supplied to the first pipe 4 and a suction direction in which the air is sucked in from the first pipe 4 as a result of the actuator 17 being controlled by the controller 18. Further, the pump 3 takes a supply state of supplying the air to the air chamber 1b by being driven in a state in which the air conveyance direction is the supply direction. In addition, the pump 3 takes a suction state of sucking the air in from the air chamber 1b by being driven in a state in which the air conveyance direction is the suction direction. To be noted, although the pump 3 is connected to the inlet port 5aP of the air chamber 1b through the first pipe 4 in the present embodiment, the configuration is not limited to this. For example, the first pipe 4 may be omitted, and the pump 3 may be directly connected to the inlet port 5aP, or may be connected to the inlet port 5aP through a duct.

Next, the flowchart illustrated in FIG. 10 will be described. The flowchart illustrated in FIG. 10 illustrates control to switch the air conveyance direction of the pump 3 in the case where the toner remainder amount in the toner storage chamber 1a has become small. To be noted, at the start of the flowchart of FIG. 10, the locking member 21 is in the locked state, and thus detachment of the toner cartridge 1 from the apparatus body 100A is restricted by the locking member 21. As illustrated in FIG. 10, the controller 18 first determines whether or not a toner supply instruction to supply the toner T from the toner cartridge 1 to the developing container 104 has been input (S1).

In the case where it is determined that the toner supply instruction has been input (S1: Yes), the controller 18 checks the toner remainder amount in the toner storage chamber 1a by using the toner remainder amount sensor 16 (S2). Next, the controller 18 determines whether or not the toner remainder amount in the toner storage chamber 1a is “out” (S3). To be noted, a state in which the toner remainder amount is “out” refers to a state in which the toner in the toner storage chamber 1a is equal to or less than a predetermined threshold value, that is, equal to or less than a predetermined amount. The threshold value may be set to an arbitrary value, and the “out” state does not necessarily indicate that there is no toner in the toner storage chamber 1a. The controller 18 determines that the toner remainder amount is “out” by obtaining a signal corresponding to a toner remainder amount of a predetermined amount or less from the toner remainder amount sensor 16.

In the case where it has been determined that the toner remainder amount in the toner storage chamber 1a is not “out” (S3: No), the controller 18 controls the actuator 17 to switch the air conveyance direction of the pump 3 to the supply direction (S4). Next, the controller 18 drives the pump 3 (S5). That is, the pump 3 transitions to the supply state. Then, the controller 18 determines whether or not M seconds have passed since the driving of the pump 3 is started (S6). In the case where it is determined that M seconds have passed (S6: Yes), the control is finished. To be noted, M seconds is an arbitrary time required for replenishing the developing container 104 with the toner T, and as a result of the pump 3 being driven for M seconds in the supply state, the toner T is normally supplied to the developing container 104.

In contrast, in the case where it is determined in step S3 that the toner remainder amount in the toner storage chamber 1a is “out” (S3: Yes), the controller 18 controls the actuator 17 to switch the air conveyance direction of the pump 3 to the suction direction (S7). Next, the controller 18 drives the pump 3 (S8). That is, the pump 3 transitions to the suction state. Then, the controller 18 determines whether or not N seconds have passed since the driving of the pump 3 is started (S9). In the case where it is determined that N seconds have passed (S9: Yes), the controller 18 stops the driving of the pump 3 (S10). To be noted, N seconds is an arbitrary time required for reducing the inner pressure of the toner cartridge 1, and in the present embodiment, as a result of the pump 3 being driven for N seconds in the suction state, the inner pressure of the toner cartridge 1 becomes approximately equal to the atmospheric pressure.

Then, the controller 18 causes the locking member 21 to transition to the unlocked state, and thus the toner cartridge 1 becomes detachable from the apparatus body 100A (S11). That is, the controller 18 causes the pump 3 to transition to the suction state before the toner cartridge 1 is detached from the apparatus body 100A. In this manner, the control is finished. According to this control, the inner pressure of the toner cartridge 1 is reduced in a state in which the second pipe 9 is connected to the toner storage chamber 1a of the toner cartridge 1. That is, the controller 18 and the actuator 17 serve as an example of a decompression mechanism that reduces the inner pressure of the toner cartridge 1.

After this, when the user moves the toner cartridge 1 in the detachment direction D2 from the attached position, the first connecting portion 4b and the second connecting portion 9b are both detached from the toner cartridge 1. Particularly, when the second connecting portion 9b is detached from the second connected portion 8 of the toner cartridge 1, the inner pressure of the toner cartridge 1 is approximately equal to the atmospheric pressure, and therefore the toner T in the toner storage chamber 1a does not jet out from the second connected portion 8. Therefore, toner leakage in the case of replacing the toner cartridge 1 can be suppressed. In addition, since the pump 3 transitions to the suction state on the basis of the toner remainder amount in the toner storage chamber 1a being in the “out” state, the user does not need to operate the air releasing valve 13 after opening the door 2, and thus the usability can be improved.

Next, a flowchart illustrated in FIG. 11 will be described. The flowchart illustrated in FIG. 11 illustrates control to switch the air conveyance direction of the pump 3 in the case where a toner cartridge detachment instruction is output from the operation panel 19. In this control, a sufficient amount of the toner T may remain in the toner storage chamber 1a of the toner cartridge 1. To be noted, at the start of the flowchart of FIG. 11, the locking member 21 is in the locked state, and thus the detachment of the toner cartridge 1 from the apparatus body 100A is restricted by the locking member 21.

As illustrated in FIG. 11, the controller 18 first determines whether or not a toner cartridge detachment instruction output from the operation panel 19 has been input (S21). The toner cartridge detachment instruction is a signal instructing to detach the toner cartridge. In the case where it is determined that the toner cartridge detachment instruction has been input (S21: Yes), the controller 18 determines whether or not the door 2 is positioned at the open position on the basis of a detection result of the door sensor 20 (S22). The controller 18 determines that the door 2 is at the open position by obtaining a signal corresponding to the door 2 positioned at the open position from the door sensor 20. In the case where it is determined that the door 2 is not positioned at the open position (S22: No), the controller 18 causes a panel of the operation panel 19 to display an instruction prompting the user to open the door 2 (S23), and returns to step S22.

In the case where it is determined that the door 2 is positioned at the open position in step S22 (S22: Yes), the controller 18 controls the actuator 17 to switch the air conveyance direction of the pump 3 to the suction direction (S24). Next, the controller 18 drives the pump 3 (S25). That is, the pump 3 is caused to transition to the suction state. Then, the controller 18 determines whether or not N seconds have passed since the driving of the pump 3 is started (S26). In the case where it is determined that N seconds have passed (S26: Yes), the controller 18 stops the driving of the pump 3 (S27).

Then, the controller 18 causes the locking member 21 to transition to the unlocked state, and thus the toner cartridge 1 becomes detachable from the apparatus body 100A (S28). That is, the controller 18 causes the pump 3 to transition to the suction state before the toner cartridge 1 is detached from the apparatus body 100A. In this manner, the control is finished. According to this control, the inner pressure of the toner cartridge 1 is reduced in a state in which the second pipe 9 is connected to the toner storage chamber 1a of the toner cartridge 1.

After this, when the user moves the toner cartridge 1 in the detachment direction D2 from the attached position, the inner pressure of the toner cartridge 1 is approximately equal to the atmospheric pressure, and therefore the toner T in the toner storage chamber 1a does not jet out from the second connected portion 8. Therefore, toner leakage in the case of replacing the toner cartridge 1 can be suppressed. In addition, since the pump 3 transitions to the suction state on the basis of input of the toner cartridge detachment instruction from the operation panel 19 or on the basis of the door 2 positioned at the open position, the user does not need to operate the air releasing valve 13 after opening the door 2, and thus the usability can be improved.

To be noted, although the door 2 positioned at the open position is confirmed by the controller 18 in step S22 in the present embodiment, the configuration is not limited to this. For example, step S22 may be omitted, and the pump 3 may be caused to transition to the suction state immediately after the input of the toner cartridge detachment instruction.

In addition, although the controller 18 checks in step S21 whether or not the toner cartridge detachment instruction has been input from the operation panel 19 in the present embodiment, the configuration is not limited to this. For example, step S21 may be omitted, and the pump 3 may be caused to transition to the pump 3 on the basis of the door 2 being positioned at the open position.

### OTHER EMBODIMENTS

In addition, although the first connecting portion 4b and the second connecting portion 9b are connected to the first connected portion 5 and the second connected portion 8 of the toner cartridge 1 from the upstream side in the detachment direction D2 in the second to fourth embodiments similarly to the first embodiment, the configuration is not limited to this. That is, the first connecting portion 4b and the second connecting portion 9b may be connected to the toner cartridge 1 from, for example, the upper side or the lower side in the gravity direction G.

In addition, although the first connecting portion 4b and the second connecting portion 9b are detached from the first connected portion 5 and the second connected portion 8 of the toner cartridge 1 by sliding the toner cartridge 1 in the detachment direction D2 in all the embodiments described above, the configuration is not limited to this. For example, the first connected portion 5 and the second connected portion 8 of the toner cartridge 1 may be detached from the first connecting portion 4b and the second connecting portion 9b by pivoting about a pivot shaft extending in the arrangement direction D1.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-104486, filed Jun. 27, 2024, which is hereby incorporated by reference herein in its entirety.

What is claimed is:

1. An image forming apparatus comprising:
an apparatus body including:
a photosensitive drum configured to bear an electrostatic latent image;
a developing container configured to store toner; and
a developing roller configured to develop the electrostatic latent image into a toner image by using the toner in the developing container; and
a toner cartridge configured to be attachable to and detachable from the apparatus body, the toner cartridge including:
a toner storage chamber configured to store the toner and provided with a discharge port through which the toner is discharged to an outside of the toner cartridge;
a filter configured to suppress passage of the toner and allow passage of air; and
an air chamber partitioned from the toner storage chamber by the filter and provided with an inlet port communicating with the air chamber,
wherein the apparatus body includes:
a pump configured to supply the air to the air chamber of the toner cartridge;
a first connecting portion configured to be connected to the inlet port of the toner cartridge and including a passage through which the air supplied from the pump and sent toward the air chamber passes; and
a second connecting portion configured to be connected to the discharge port of the toner cartridge and including a passage through which the toner discharged from the discharge port together with the air and conveyed toward the developing container passes, and
wherein in a case where the toner cartridge is detached from the apparatus body, connection between the first connecting portion and the inlet port is released such that the inlet port is opened before connection between the second connecting portion and the discharge port is released.

2. The image forming apparatus according to claim 1, wherein the apparatus body includes a pipe through which the toner discharged together with the air from the toner cartridge through the second connecting portion and conveyed toward the developing container passes, and
wherein the toner stored in the toner storage chamber is conveyed to the developing container through the second connecting portion and the pipe, by the air supplied to the toner cartridge and supplied from the pump through the inlet port.

3. The image forming apparatus according to claim 1, wherein the toner cartridge is detached from the apparatus body by being moved in a detachment direction from an attached position where the toner cartridge is attached to the apparatus body,
wherein the image forming apparatus further includes:
a first sealing member configured to seal a gap between the first connecting portion and a portion constituting the inlet port in a state in which the first connecting portion is connected to the inlet port; and
a second sealing member configured to seal a gap between the second connecting portion and a portion constituting the discharge port in a state in which the second connecting portion is connected to the discharge port,
wherein the first connecting portion is inserted into the air chamber by a first distance from the first sealing member in the detachment direction in a case where the toner cartridge is positioned at the attached position, and
wherein the second connecting portion is inserted into the air chamber by a second distance longer than the first distance from the second sealing member in the detachment direction in the case where the toner cartridge is positioned at the attached position.

4. The image forming apparatus according to claim 3, wherein the discharge port is disposed at a position that is above the inlet port and different from the inlet port in a direction orthogonal to both the detachment direction and a gravity direction.

5. An image forming apparatus comprising:
an apparatus body including:
a photosensitive drum configured to bear an electrostatic latent image;
a developing container configured to store toner; and
a developing roller configured to develop the electrostatic latent image into a toner image by using the toner in the developing container;
a toner cartridge configured to be attachable to and detachable from the apparatus body, the toner cartridge including:
a toner storage chamber configured to store the toner and provided with a discharge port through which the toner is discharged to an outside of the toner cartridge;
a filter configured to suppress passage of the toner and allow passage of air; and
an air chamber partitioned from the toner storage chamber by the filter and provided with an inlet port communicating with the air chamber; and
a valve member,
wherein the apparatus body includes:
a pump configured to supply the air to the air chamber of the toner cartridge; and
a supply pipe including a passage through which the air supplied from the pump and sent to the air chamber passes, and
wherein the valve member is configured to be transitioned to a closed state in which the air chamber does not communicate with the outside of the toner cartridge and an open state in which the air chamber communicates with the outside of the toner cartridge.

6. The image forming apparatus according to claim 5, wherein the toner cartridge is detached from the apparatus body by being moved in a detachment direction from an attached position where the toner cartridge is attached to the apparatus body, and
wherein the valve member is provided in a surface of the toner cartridge, the surface facing in the detachment direction.

7. The image forming apparatus according to claim 5, wherein the apparatus body includes:
an opening portion; and
a door movable to a closed position where the door closes the opening portion and an open position where the door opens the opening portion,
wherein the toner cartridge is detached from the apparatus body through the opening portion by being moved in a detachment direction in a case where the door is positioned at the open position, and
wherein the valve member is disposed to face the door positioned at the closed position.

8. The image forming apparatus according to claim 5, wherein the apparatus body includes:
an opening portion; and
a door movable to a closed position where the door closes the opening portion and an open position where the door opens the opening portion, and
wherein the valve member is transitioned from the closed state to the open state in conjunction with movement of the door from the closed position to the open position.

9. The image forming apparatus according to claim 8, wherein the valve member is provided in the supply pipe.

10. An image forming apparatus comprising:
an apparatus body including:
a photosensitive drum configured to bear an electrostatic latent image;
a developing container configured to store toner; and
a developing roller configured to develop the electrostatic latent image into a toner image by using the toner in the developing container; and
a toner cartridge configured to be attachable to and detachable from the apparatus body, the toner cartridge including:
a toner storage chamber configured to store the toner and provided with a discharge port through which the toner is discharged to an outside of the toner cartridge;
a filter configured to suppress passage of the toner and allow passage of air; and
an air chamber partitioned from the toner storage chamber by the filter and provided with an inlet port communicating with the air chamber,
wherein the apparatus body includes:
a pump configured to be transitioned to a supply state in which the pump supplies the air to the air chamber and a suction state in which the pump sucks the air from the air chamber; and
a controller configured to cause the pump to be transitioned to the supply state or the suction state.

11. The image forming apparatus according to claim 10, wherein the controller is configured to cause the pump to be transitioned to the suction state before the toner cartridge is detached from the apparatus body.

12. The image forming apparatus according to claim 10, further comprising a toner remainder amount sensor configured to output a signal corresponding to a remainder amount of the toner stored in the toner cartridge,
wherein the controller is configured to cause the pump to be transitioned to the pump in a case where the signal corresponding to the remainder amount of the toner of a predetermined amount or less is obtained from the toner remainder amount sensor.

13. The image forming apparatus according to claim 10, wherein the apparatus body includes:
an opening portion; and
a door movable to a closed position where the door closes the opening portion and an open position where the door opens the opening portion,
wherein the image forming apparatus further includes a door sensor configured to output a signal differing between a case where the door is at the closed position and a case where the door is at the open position, and
wherein the controller causes the pump to be transitioned to the suction state in a case where the signal corresponding to the case where the door is at the open position is obtained from the door sensor.

14. The image forming apparatus according to claim 10, further comprising an operation portion configured to output a signal instructing to detach the toner cartridge from the apparatus body,
wherein the controller causes the pump to be transitioned to the suction state in a case where the signal is input from the operation portion.
